(19) United States
(12) Patent Application Publication
(10) Pub. No.: US 2013/0120494 A1
(43) Pub. Date: May 16, 2013

(54) REDUCING CONDENSATION ACCUMULATION IN PRINTING SYSTEMS

(71) Applicants: Borden H. Mills, III, Webster, NY (US); Thomas A. Henderson, Rochester, NY (US); James H. Hurst, Rochester, NY (US); John L. Hryhorenko, Webster, NY (US); W. Charles Kasiske, JR., Webster, NY (US); Alan E. Rapkin, Pittsford, NY (US); Timothy J. Hawryschuk, Miamisburg, OH (US); Andrew Ciaschi, Pittsford, NY (US)

(72) Inventors: Borden H. Mills, III, Webster, NY (US); Thomas A. Henderson, Rochester, NY (US); James H. Hurst, Rochester, NY (US); John L. Hryhorenko, Webster, NY (US); W. Charles Kasiske, JR., Webster, NY (US); Alan E. Rapkin, Pittsford, NY (US); Timothy J. Hawryschuk, Miamisburg, OH (US); Andrew Ciaschi, Pittsford, NY (US)

(21) Appl. No.: 13/612,915

(22) Filed: Sep. 13, 2012

Related U.S. Application Data
(60) Provisional application No. 61/541,192, filed on Sep. 30, 2011.
(60) Provisional application No. 61/541,204, filed on Sep. 30, 2011.
(60) Provisional application No. 61/541,212, filed on Sep. 30, 2011.

(51) Int. Cl. B41J 2/165

(52) U.S. Cl. CPC B41J 2/16535
USPC 347/33

(57) ABSTRACT

A printing system includes one or more printing system components positioned opposite a moving print media. A wick assembly can be attached to a printing system component to wick condensation away from a surface of the printing system component that is opposite the moving print media. A heating element can be in contact with one or both of the wick assembly and a printing system component. A protective layer can be attached to the surface of a printing system component that is opposite the moving print media to prevent condensation from forming on the component. A vacuum assembly can be positioned opposite the moving print media to produce suction over the print media that pushes humid air or some condensation into the vacuum assembly.

### CROSS REFERENCE TO RELATED APPLICATIONS

This application claims the benefit of U.S. Provisional Application No. 61/541,192 (docket K000384) filed on Sep. 30, 2011, U.S. Provisional Application No. 61/541,204 (docket K000618) filed on Sep. 30, 2011, and U.S. Provisional Application No. 61/541,212 (docket K000619) filed on Sep. 30, 2011. This application is related to U.S. patent application Ser. No. 13/326,421 (docket K000451) filed on Dec. 15, 2011.

### TECHNICAL FIELD

The present invention generally relates to printing systems and more particularly to a system and method that compensates for condensation in a printing system.

### BACKGROUND

In a digitally controlled printing system, a print media is directed through a series of components. The print media can be a cut sheet or a continuous web. A web or cut sheet transport system physically moves the print media through the printing system. As the print media moves through the printing system, liquid, for example, ink, is applied to the print media by one or more printheads. This is commonly referred to as jetting of the liquid. The jetting of the liquid, along with the moisture evaporating from the liquid previously applied to the print media, produces warm humid air in a clearance gap located between the printhead and the print media.

Multiple printheads are located in groups known as lineheads. Each linehead typically applies a different color or type of liquid. To avoid mixing the liquids applied by the multiple lineheads, dryers are located between selected lineheads. These dryers increase evaporation of moisture from the applied liquid, but also increase the temperature of the print media. As the temperature of the print media is increased, evaporation increases as more liquid is applied by subsequent lineheads in the narrow clearance gap between the printheads and the print media. In addition, although the dryers remove some of the moisture from the surface of the print media by applying a vacuum as the print media passes under the dryer, some of the moisture remains adjacent to the surface of the print media. The physical movement of the print media through the printing system then draws the warm humid air through the printing system.

The printheads are typically located and aligned by a support structure. If the support structure is at a lower temperature than the dew point of warm humid air in the clearance gap, condensation can accumulate on the surface of the support structure that is opposite the print media. Condensation that sufficiently accumulates can drip or otherwise touch the print media and adversely affect print quality.

### SUMMARY

According to one aspect, a printing system component is positioned opposite or over a moving print media. A wick assembly can be attached to the printing system component to wick condensation away from the surface of the printing system component that is opposite or over the print media.

A heating element can be included within a wick assembly or in contact with the wick assembly, a surface of a printing system component, or both a surface of the printing system component and the wick assembly. The heating element can heat the wick assembly to increase the amount of condensation evaporated from the wick assembly. The heating element can heat the surface of the printing system component to reduce the amount of condensation that forms on the surface of the printing system component that is opposite or over the print media.

A vacuum assembly can be included in the printing system and positioned opposite the moving print media. The vacuum assembly is configured to produce suction over the print media that pushes humid air or some condensation into the vacuum assembly.

The printing system component can include a protective layer attached to the surface of the printing system component that is opposite or over the print media. The protective layer can prevent condensation from accumulating on the printing system component. A wick assembly can be attached to the protective layer. A heating element can be in contact with the protective layer.

The printing system component can be implemented as one or more lineheads that each include a printhead or printheads that jet ink or liquid on a moving print media, a support structure that aligns the printhead or printheads, or other types of printing system components that interact with the print media as the print media is transported through a printing system. These components include, but are not limited to, image quality sensors, image registration sensors, color sensors, or ink or media coating curing systems such as UV sources.

### BRIEF DESCRIPTION OF THE DRAWINGS

In the detailed description of the example embodiments of the invention presented below, reference is made to the accompanying drawings, in which:

FIG. 1 is a schematic side view of a digital printing system for continuous web printing on a print media in an embodiment in accordance with the invention;

FIG. 2 is a schematic side view of components in a portion of the printing system, showing increased condensation regions in an embodiment in accordance with the invention;

FIG. 3 is a schematic view of a surface of a support structure that is opposite the print media in an embodiment in accordance with the invention;

FIG. 4 is a schematic side view of one example of a wick assembly in an embodiment in accordance with the invention;

FIG. 5 is a schematic side view of another example of a wick assembly in an embodiment in accordance with the invention

FIG. 6 is a schematic side view of a portion of a printing system in an embodiment in accordance with the invention;

FIG. 7 is a perspective view of a surface of the protective layer that faces the print media in an embodiment in accordance with the invention;

FIG. 8 is a perspective view of a surface of the protective layer that faces the support structure in an embodiment in accordance with the invention;

FIG. 9 illustrates a side and top view of a sealing structure in an embodiment in accordance with the invention;

FIG. 10 is a schematic side view of a portion of a digital printing system in a third embodiment in accordance with the invention; and

FIGS. 11 and 12 are schematic side views of a portion of a digital printing system in a fourth embodiment in accordance with the invention.

### DETAILED DESCRIPTION

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

In the above described ink jet technologies, drop size is a function of ink viscosity, which is affected by ink temperature. Thus, the temperature of the ink introduced into the ink jetting mechanisms is controlled within certain temperature limits in an embodiment in accordance with the invention.

Additionally, there are typically two types of print media used with inkjet printing systems. The first type is commonly referred to as a continuous web while the second type is commonly referred to as a cut sheet(s). The continuous web of print media refers to a continuous strip of media, generally originating from a source roll. The continuous web of print media is moved relative to the inkjet printing system components via a web transport system, which typically include drive rollers, web guide rollers, and web tension sensors. Cut sheets refer to individual sheets of print media that are moved relative to the inkjet printing system components via rollers and drive wheels or via a conveyor belt system that is routed through the inkjet printing system.

The invention described herein is applicable to both types of printing technologies. As such, the terms printhead and linehead, as used herein, are intended to be generic and not specific to either technology. Additionally, the invention described herein is applicable to both types of print media. As such, the terms print media and web, as used herein, are intended to be generic and not as specific to either type of print media or the way in which the print media is moved through the printing system.

The invention is described in conjunction with a linehead having a support structure in a printing system. But embodiments in accordance with the invention can be implemented with other types of components in a printing system, including, but not limited to, image quality sensors, image registration sensors, color sensors, or ink or media coating curing systems such as UV sources. As such, the term “printing system component” is intended to be generic and not specific to any type of printing system component.

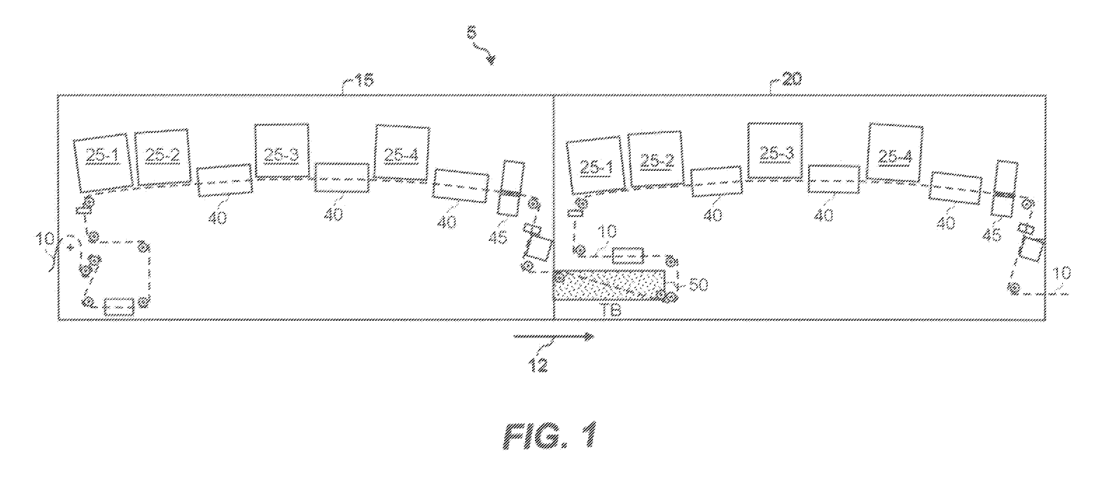

The terms “upstream” and “downstream” are terms of art referring to relative positions along the transport path of the print media; points on the transport path move from upstream to downstream. In FIGS. 1-7, 11 and 12, the media moves in a direction indicated by feed direction arrow 12. Where they are used, terms such as “first”, “second”, and so on, do not necessarily denote any ordinal or priority relation, but are simply used to more clearly distinguish one element from another.

Referring now to FIG. 1, there is shown a printing system for continuous web printing on a print media. The printing system 5 includes a first module 15 and a second module 20, each of which includes lineheads 25, dryers 40, and a quality control sensor 45. Although FIG. 1 depicts each module with four lineheads 25, three dryers 40, and one quality control sensor 45, embodiments in accordance with the invention are not limited to this construction. A printing system can include any number of lineheads, any number of dryers, and any number of quality control sensors. In the illustrated embodiment, the lineheads 25 and dryers 40 in each printing module are mounted at particular angles so that the print media 10 is pressed against transport rollers (not shown) positioned on the underside of the print media 10 as the print media is transported through the printing system 5.

The first module 15 and the second module 20 include a web tension system (not shown) that serves to physically move the print media 10 through the printing system 5 in the feed direction 12 (left to right as shown in the figure). The print media 10 enters the first module 15 from a source roll (not shown). The linehead(s) 25 of the first module applies ink to one side of the print media 10. As the print media 10 feeds into the second module 20, a turnover mechanism (TB) 50 inverts the print media 10 so that linehead(s) 25 of the second module 20 can apply ink to the other side of the print media 10. The print media 10 then exits the second module 20 and is collected by a receiving unit (not shown). For descriptive purposes only, the lineheads 25 are labeled a first linehead 25-1, a second linehead 25-2, a third linehead 25-3, and a fourth linehead 25-4.

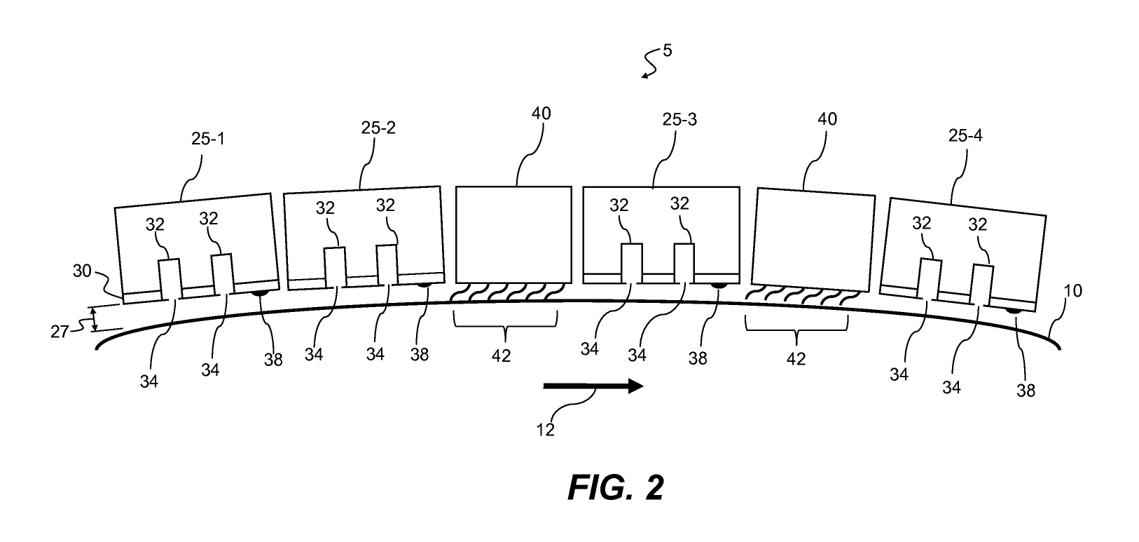

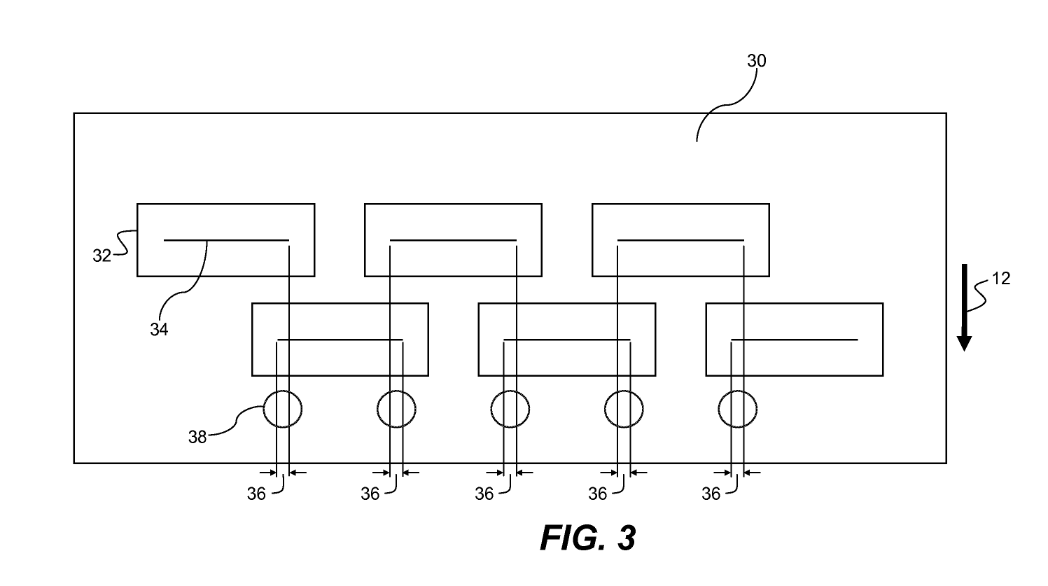

FIG. 2 is a schematic side view of components in a portion of the printing system 5, showing increased condensation regions in an embodiment in accordance with the invention. As the print media 10 is directed through the printing system 5, the lineheads 25, which typically include a plurality of printheads 32, apply ink or another liquid to the print media 10 via the nozzle arrays 34 of the printheads 32. The printheads 32 within the linehead 25 are located and aligned by a support structure 30. The support structure 30 can be very rigid and thus high in thermal mass to maintain an accurate relationship between the positions of the printheads. (One such arrangement of printheads 32 in the linehead 25 is shown in FIG. 3.)

As the ink applied to the print media 10 dries by evaporation, the humidity of the air above the print media 10 rises in the clearance gap 27 between the printer components (for example, lineheads 25 and dryers 40) and the print media 10. In one embodiment, the clearance gap 27 is small and precisely controlled to maintain accuracy of each jet of ink coming from each printhead. To simplify the description, terms such as moisture, humid, humidity, and dew point that in a proper sense relate only to water in either a liquid or gaseous form, are used to refer to the corresponding liquid or gaseous phases of the solvents that make up a large portion of the inks and other coating fluids applied by the printheads 32. When the ink or other coating fluid is based on a solvent other than water, these terms are intended to refer to the liquid and gaseous forms of such solvents in a corresponding manner.

As the print media 10 moves in the feed direction 12, each dryer increases the temperature of the print media. As the temperature of the print media 10 is increased, the rate of evaporation of the liquid applied by each linehead 25 is also increased. In addition, as the print media moves through each dryer 40, some of the moisture evaporated by the dryer is dragged along or entrained by the moving print media 10, even though a vacuum can be drawn in the dryers to remove the moisture. As a result, a convective current develops and causes the warm humid air to flow downstream. When this happens, the warm humid air in the clearance gap 27 often comes into contact with downstream components of the printing system 5 in increasing amounts, such as, for example, the third linehead 25-3, and more particularly, the support structure 30 of the third linehead 25-3, and to an even greater extent the support structure of the fourth linehead 25-4. If the temperature of a support structure 30 is below the dew point of the warm humid air in the clearance gap 27, moisture condenses out of the humid air onto the support structure 30 of the lineheads. As ink is continually being printed on the print media 10, which then passes through the dryers 40 to dry the ink on the print media 10, moisture is continually being added to the air in the clearance gap 27. This continuous supply of moist air often leads to large amounts of moisture condensing on downstream components of the printing system 5. Typically, there is an increased condensation region 38 on the downstream portion of the support structure 30 (also shown in FIG. 3). If sufficient condensation accumulates on one or more of the printing system components, it can drip onto or otherwise touch the print media 10 which adversely affects print quality.

Warm humid air produced by the printheads 32 of the first linehead 25-1 under certain circumstances produces sufficient moisture in clearance gap 27 which causes the moisture to condense on the downstream portion of the support structure 30 of the first linehead 25-1. If multiple lineheads 25 are printing onto the print media 10, this problem is compounded. The clearance gap 27 under the second linehead 25-2 will include moisture produced by the printing of both the first and second lineheads 25-1, 25-2. As a result, condensation can be more of a problem for the downstream lineheads 25 (for example, the fourth linehead 25-4) than for the upstream lineheads 25 (for example, the first linehead 25-1).

After the ink is jetted onto the print media 10, the print media 10 passes beneath the one or more dryers 40 which apply heat 42 to the ink on the print media. The applied heat 42 accelerates the evaporation of the water or other solvents in the ink. Although the dryers 40 often include an exhaust duct for removing the resulting warm humid air from above the print media, some warm humid air can still be dragged along by the moving print media 10 as it leaves the dryer 40. This can also result in relatively high humidity in the clearance gap 27 between the print media 10 and downstream components such as the third and fourth lineheads 25-3, 25-4.

Additionally, the print media 10 remains at an increased temperature after leaving the dryer 40 causing the ink to continue to evaporate, thereby adding moisture into the clearance gap 27. As such, the condensation issue is further amplified on lineheads 25 downstream of a dryer 40.

Referring now to FIG. 3, a surface of the support structure 30 that is opposite or over the print media 10 and separated by the clearance gap 27 is shown. The printheads 32 are aligned in a staggered formation, with upstream and downstream printheads 32, such that the nozzle arrays 34 produce overlap regions 36. The overlap regions 36 enable the print from overlapped printheads 32 to be stitched together without a visible seam through the use of appropriate stitching algorithms that are known in the art. These stitching algorithms ensure that the amount of ink printed in the overlap region 36 is not higher than other portions of the print.

As discussed earlier, increased condensation regions 38 typically form along the downstream portion of the support structure 30. If sufficient condensation accumulates on one or more of the printing system components, it can drip onto or otherwise touch the print media 10 which adversely affects print quality.

Other embodiments in accordance with the invention can include any number of printheads 32. Additionally, the printheads 32 can be arranged differently from the arrangement shown in FIG. 3.

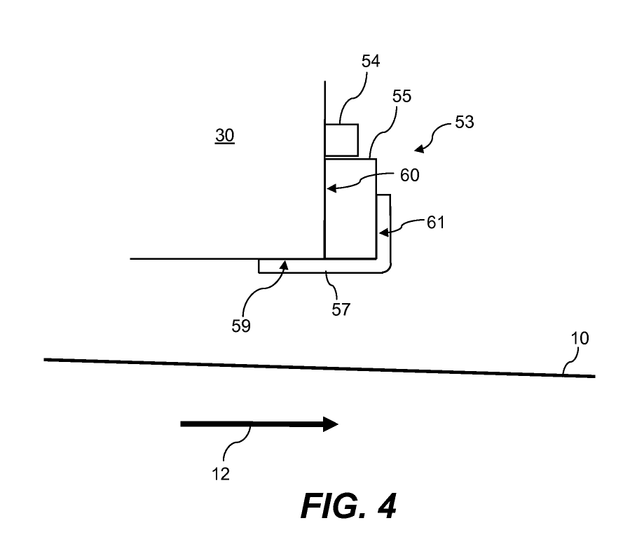

FIG. 4 is a schematic side view of one example of a wick assembly in an embodiment in accordance with the invention. Wick assembly 53 attaches to a downstream corner or portion of the support structure 30 in one embodiment in accordance with the invention. Wick assembly 53 includes textile pad 55 surrounded on two sides by textile pad 57. Wick assembly 53 can be configured differently in other embodiments in accordance with the invention. By way of example only, textile pad 57 can be positioned on only the bottom side (the side that faces the print media 10).

In the illustrated embodiment, surface 59 of the textile pad 57 attaches to a portion of the downstream surface of the support structure 30 that is opposite or over the print media 10, and surface 60 of the textile pad 55 attaches to the vertical surface of the support structure 30. Surfaces 59 and 61 of textile pad 57 attach to textile pad 55. As discussed earlier, condensation is more likely to accumulate and build up in certain regions of the support structure 30, such as towards the downstream side of the support structure 30 compared to the upstream side of the support structure 30. Wick assembly 53 removes some or all of the accumulating condensation from the surface of the support structure 30.

Textile pad 55 can attach to the support structure 30 using any attachment material, including, but not limited to, adhesive or magnetic materials. The attachment materials can permanently attach or removably attach textile pads 55, 57 (either individually or in combination) to the support structure 30.

Textile pad 57 transports the condensation away from the surface of the support structure 30 opposite the print media 10 using capillary pressure. Textile pad 55 collects the condensation until evaporation removes the collected condensation from textile pad 55. Textile pads 55 and 57 can attach to each other by several methods, including, but not limited to, a perforated adhesive sheet (not shown) or by needling the fibers of textile pad 57 into textile pad 55.

Heating element 54 can be attached to, or in contact with, a surface of the support structure 30 to heat the surface of the support structure 30 or the wick assembly 53 to increase the amount of condensation evaporated from the wick assembly 53 or the support structure 30. Heating element 54 can be included within the wick assembly, such as, for example, within the textile pad 55. Heating element 54 can be implemented as a single heating element or multiple heating elements. Heating element 54 can be attached to, or in contact with, the wick assembly 53, the support structure 30, a linehead, both the wick assembly 53 and the support structure 30, both the linehead and the wick assembly 53, or the linehead, the support structure 30, and the wick assembly 53.

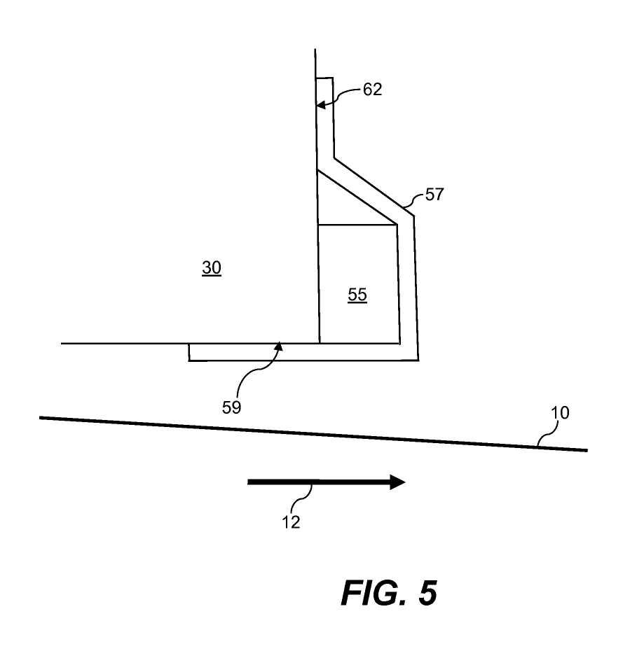

In another embodiment shown in FIG. 5, surfaces 59 and 62 of textile pad 57 are removably attached to the support structure 30 so that textile pad 57 is in direct contact with, but not attached to, textile pad 55. Not attaching textile pad 57 to textile pad 55 allows textile pad 57 to be replaced with a new textile pad when desired or needed.

Textile pad 55 can be made of needled polyester fibers or any other absorbent material that can transport and store the condensation. Textile pad 57 can be made of the same material as textile pad 55 or of a different material that can transport the condensation by means of capillary pressure.

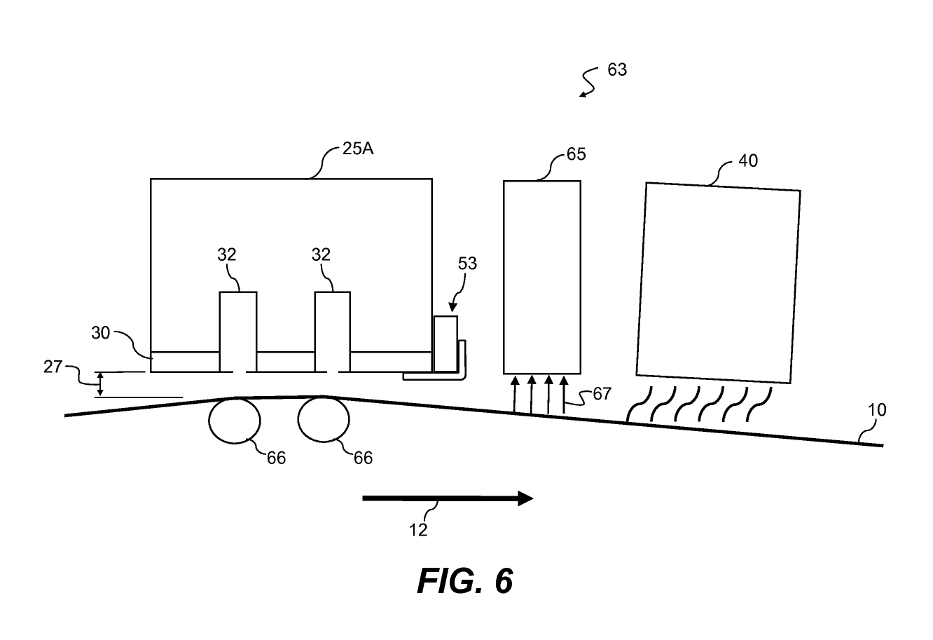

Referring now to FIG. 6, there is shown a schematic side view of a portion of a printing system in an embodiment in accordance with the invention. Printing system 63 includes linehead 25A, dryer 40, and vacuum assembly 65. As the print media 10 is directed through the printing system 63, the printheads 32 apply ink or another liquid onto the print media 10. As the ink applied to the print media 10 dries by evaporation, the humidity of the air above the print media 10 rises in the clearance gap 27 between the printer components (for example, linehead 25A and dryer 40) and the print media 10. Wick assembly 53 removes some or all of the accumulating condensation from the surface of the support structure 30.

The clearance gap 27 increases towards the downstream edge of linehead 25A by virtue of the relative angles of the linehead 25A, dryer 40, and the print media transport rollers 66 that are located directly opposite the printheads to ensure the accuracy of clearance gap 27. Increasing the clearance gap 27 towards the downstream edge of the linehead 25A increases the space available for wick assembly 53 without increasing the risk of contact between the print media and wick assembly 53. Contact between the print media 10 and textile pad 57 can smear undried ink on the print media.

Vacuum assembly 65 is positioned between the linehead 25A and the dryer 40 in an embodiment in accordance with the invention. As the print media 10 moves in the feed direction 12, the warm humid air adjacent to the print media 10 is dragged along or entrained by the moving print media 10 towards the dryer 40. The vacuum assembly 65 is configured to produce suction 67 over the print media 10 that pushes the warm humid air in the clearance gap 27, along with some or all of the condensation dragged or entrained by the moving print media 10, into the vacuum assembly 65. By stripping the entrained humid air away from the print media 10, the vacuum assembly 65 reduces the moisture level in the clearance gap 27 between the print media 10 and printer components that are located downstream of the vacuum assembly 65.

The suction 67 produced by the vacuum assembly 65 is uniform across the print media 10 in an embodiment in accordance with the invention. It is contemplated, however, that the suction 67 can vary along the width of the print media 10, for example, having increased suction corresponding to the center of the print media 10.

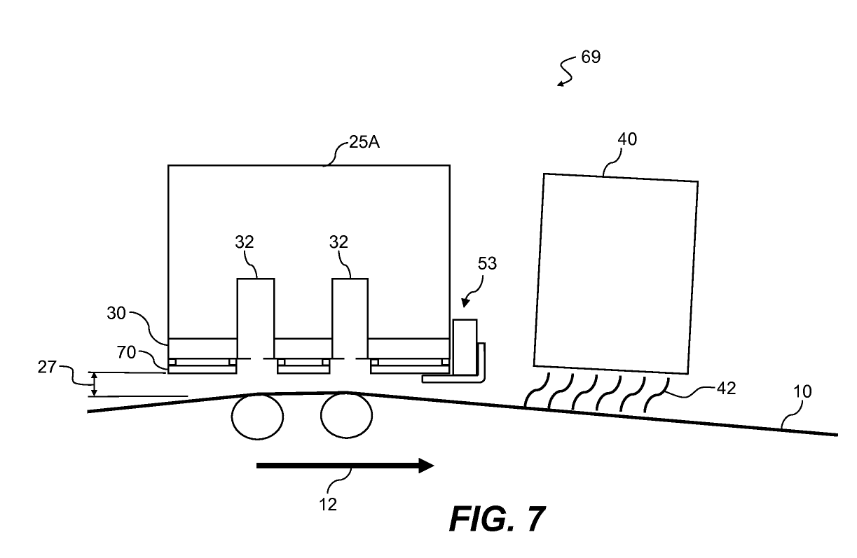

FIG. 7 is a schematic side view of a portion of a printing system in another embodiment in accordance with the invention. Printing system 69 includes the linehead 25A and the dryer 40. The linehead 25A includes the wick assembly 53 and a protective layer 70. The protective layer 70 is attached to the side of the support structure 30 that is opposite or over the print media 10. The protective layer 70 can attach to the support structure 30 using any attachment material, including, but not limited to, adhesive or magnetic materials. The attachment materials can permanently attach or removably attach the protective layer 70 to the support structure 30.

The protective layer 70 is non-porous and serves to prevent condensation from accumulating on the support structure 30. The protective layer 70 also provides some protection from physical damage to the support structure 30, for example, protection from physical damage caused by an impact of the print media 10 against the bottom of the support structure 30. Relatively speaking, the protective layer 70 has a large surface area and a small thickness, for example 1 mm. As such, the protective layer 70 has a low thermal capacity and approaches the ambient temperature or dew point of the warm humid air in the clearance gap 27. Therefore, the temperature difference between the warm humid air and the protective layer 70 approaches zero, and as such, condensation is less likely to form on the protective layer 70.

The protective layer 70 is made of material having a high thermal conductivity, such as aluminum or copper, in an embodiment in accordance with the invention. The high thermal conductivity of the protective layer 70 helps to distribute heat more uniformly across the protective layer so that the temperature of the entire surface will rise more uniformly. Increasing the temperature of the protective layer 70 reduces or prevents condensation from forming and accumulating on the surface of the protective layer 70 that faces the print media 10.

Additionally, the protective layer 70 has higher emissivity (e.g., greater than 0.75) to better absorb thermal energy radiating off of the print media 10 in an embodiment in accordance with the invention. For example, the protective layer 70 is preferably anodized black in color. Alternatively, the protective layer 70 can be another dark color. Absorption of the thermal energy radiating off of the print media 10 passively increases the temperature of the protective layer 70.

In other embodiments in accordance with the invention, the protective layer 70 can be made of a material having a lower thermal conductivity, such as for example, other metal materials and ceramic materials. If materials having a lower thermal conductivity are used, a heater may be used to actively heat the protective layer to increase the temperature of the entire surface of the protective layer 70.

The wick assembly 53 is attached to the protective layer 70 to remove some or all of the condensation that accumulates on the protective layer 70. The wick assembly 53 can be constructed as previously described. The wick assembly 53 can attach to the protective layer 70, or to the protective layer 70 and the support structure 30, using any of the techniques previously described.

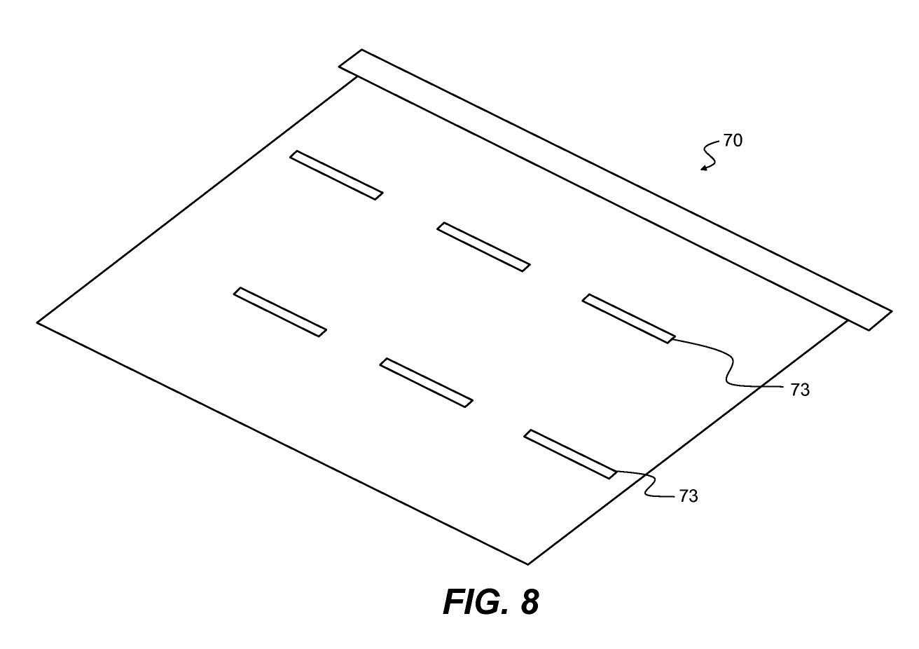

Referring now to FIG. 8, there is shown a perspective view of a surface of the protective layer that is opposite or over the print media in an embodiment in accordance with the invention. Slots 73 are formed in and through the protective layer 70 in the illustrated embodiment. The locations of the slots 73 correspond to the locations of the printheads 32 in the support structure 30 (see FIG. 3), allowing ink to be jetted onto the print media 10.

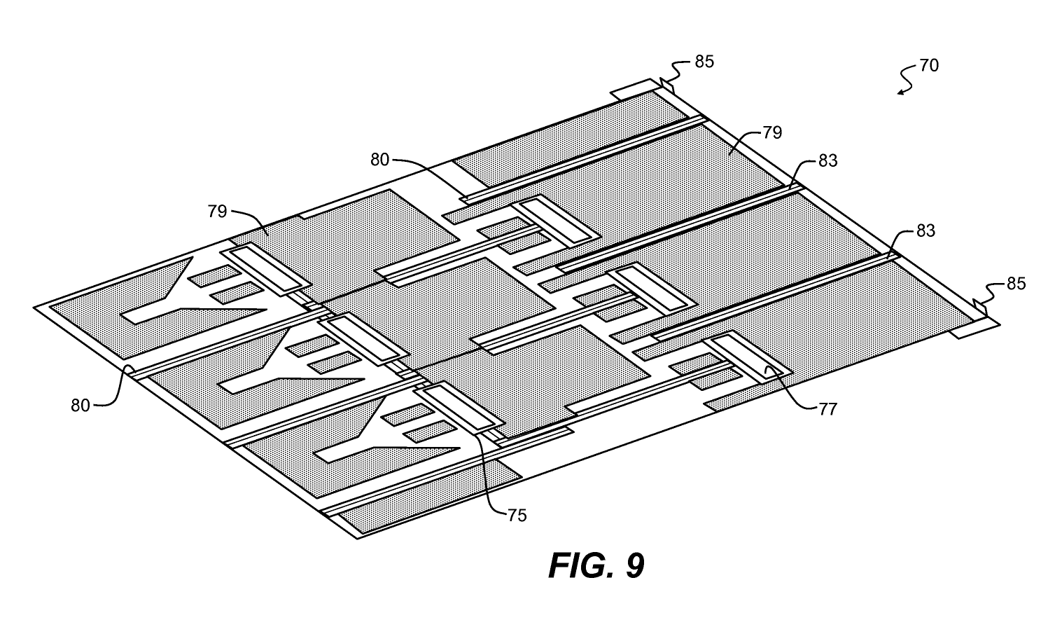

FIG. 9 is a perspective view of a surface of the protective layer that is adjacent to the support structure in an embodiment in accordance with the invention. Sealing structures 75 are disposed around the slots 73 formed in the protective layer 70. The sealing structures 75 include openings 77. The locations of the openings 77 correspond to the locations of the slots 73 in the protective layer 70 (see FIG. 8), allowing ink to be jetted onto the print media 10.

An attachment material 79 is in contact with regions of the surface of the protective layer 70 and is used to attach and hold the protective layer 70 to the support structure 30. For example, in one embodiment, the attachment material is a thin layer of a magnetic material that covers selected regions of the protective layer 70.

The protective layer 70 includes expansion joints 83 that extend through the protective layer 70. The expansion joints allow the protective layer 70 to expand and contract as the temperature of the protective layer 70 changes. A cover 80 covers the expansion joints 83 formed in the protective layer 70. The cover 80 prevents moisture from passing through the expansion joints 83. The cover 80 can be made of any material, such as, for example, tape.

Locating tabs 85 are positioned along one edge of the protective layer 70 in an embodiment in accordance with the invention. The locating tabs 85 assist in properly positioning the protective layer 70 under the support structure 30 and holding the protective layer 70 in place once positioned. Although only two locating tabs 85 are shown in FIG. 9, other embodiments in accordance with the invention can include any number of locating tabs positioned at different locations on the protective layer 70.

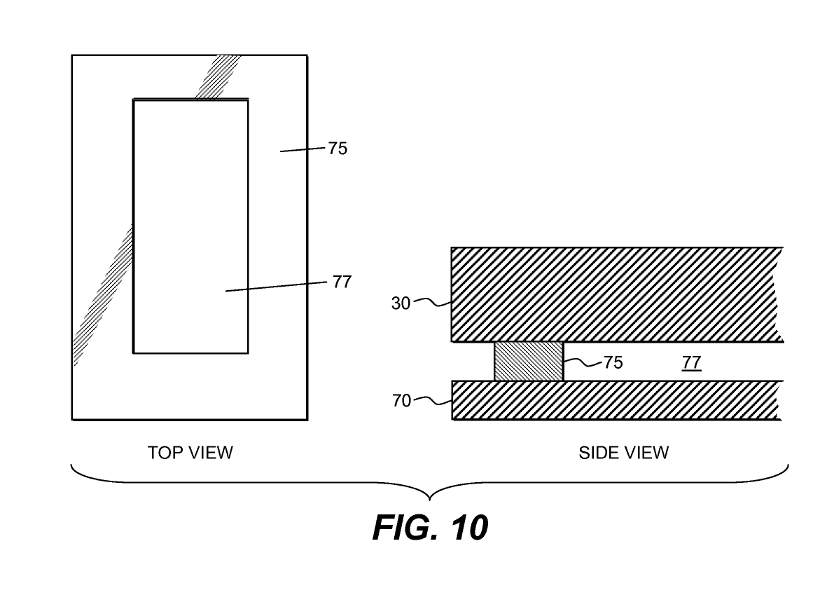

Referring now to FIG. 10, there is shown a side and top view of a sealing structure 75 in an embodiment in accordance with the invention. The sealing structure 75 is made of a compressive material, such as for example, foam. When the protective layer 70 is attached to the support structure 30, the sealing structures 75 compress against the surface of the support structure 30 to produce an air tight (or nearly air tight) seal. The sealing structures 75 prevent moisture laden air from entering into any spaces that may reside between the support structure 30 and the protective layer 70.

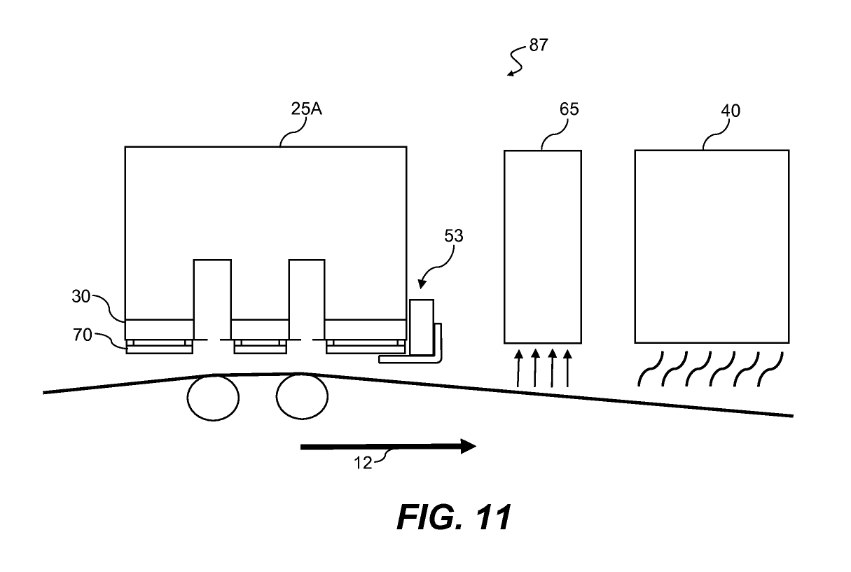

FIG. 11 is a schematic side view of a portion of a printing system in a third embodiment in accordance with the invention. Printing system 87 includes the linehead 25A, vacuum assembly 65, and the dryer 40. The linehead 25A includes the wick assembly 53 and the protective layer 70. The protective layer 70 is attached to the support structure 30.

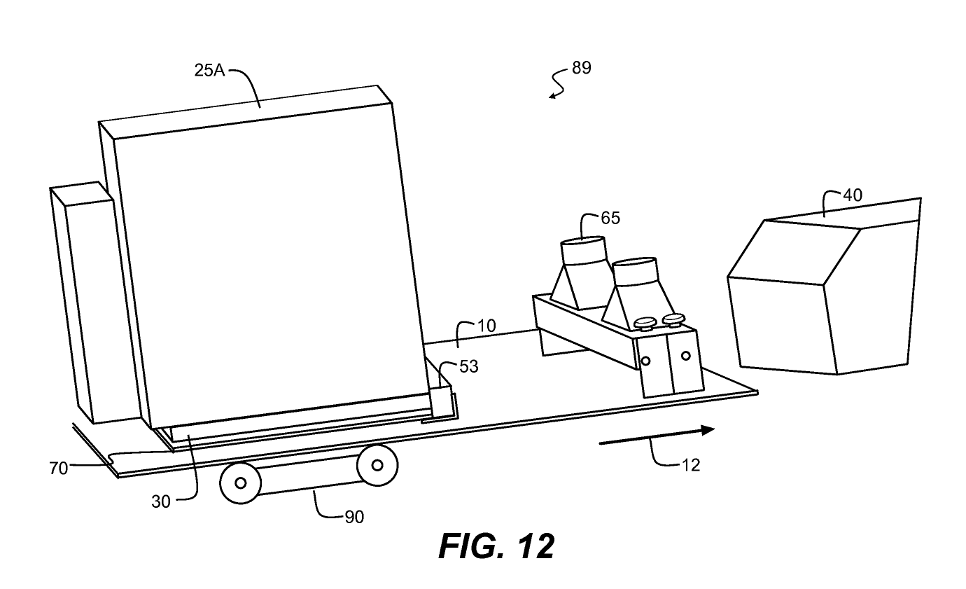

Referring now to FIG. 12, there is shown a portion of a printing system in a fourth embodiment in accordance with the invention. Printing system 89 includes the linehead 25A, vacuum assembly 65, and the dryer 40. The linehead 25A includes the wick assembly 53 and the protective layer 70. A roller assembly 90 is in contact with a surface of the print media that does not receive jetted ink. The roller assembly 90 supports and guides the print media 10 to prevent the print media 10 from fluttering or otherwise moving. The roller assembly 90 is spring loaded against the protective layer 70, or against the support structure 30 in those embodiments that do not include the protective layer 70. The roller assembly 90 is set to the height of the clearance gap 27 (i.e., the gap between the print media and the protective layer or the gap between the print media and the support structure).

Embodiments in accordance with the invention can include a protective layer 70 on any number of lineheads 25 in a printing system. By way of example only, a protective layer 70 can be included on every linehead 25 in a printing system, or on select lineheads 25 that are more prone to condensation accumulation. Additionally, embodiments in accordance with the invention can include a wick assembly 53 on any number of lineheads 25 in a printing system. By way of example only, a wick assembly 53 can be included on every linehead 25 in a printing system, or on select lineheads 25 that are more prone to condensation accumulation. And finally, embodiments in accordance with the invention can include one or more vacuum assemblies 65 in a printing system. By way of example only, a vacuum assembly can be included downstream from every linehead 25, or a vacuum assembly 65 can be downstream from only select lineheads in a printing system.

Embodiments in accordance with the invention can include one or more wick assemblies, one or more protective layers and one or more wick assemblies, one or more vacuum assemblies and one or more wick assemblies, or one or more protective layers, one or more vacuum assemblies, and one or more wick assemblies. Additionally, one or more heating elements can be included in the embodiments.

In alternative embodiments, the protective layer, the vacuum assembly, the heating element, or the wick assembly can be used with other types of printing system components that interact with the print media as the print media is transported past them. These components include, for example, image quality sensors, image registration sensors, color sensors, ink or media coating curing systems such as UV sources, web tension devices, web guiding structures such as rollers and turnover mechanisms, and combinations thereof.

The invention has been described in detail with particular reference to certain preferred embodiments thereof, but it will be understood that variations and modifications can be effected within the spirit and scope of the invention. And even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

1. A printing system component includes a wick assembly attached to the component.

2. The printing system component in clause 1 can include a protective layer connected to a surface of the printing system component that is opposite a moving print media.

3. The printing system component in clause 1 or clause 2 can include a heating element within the wick assembly or in contact with the wick assembly, a surface of the printing system component, or the protective layer, individually or in combinations of some or all of the wick assembly, a surface of the printing system component, and the protective layer.

4. The printing system component as in any one of clauses 1-3, where the wick assembly can be attached to a downstream portion of the printing system component.

5. The printing system component as in any one of clauses 1-4, where a surface of the first textile pad can be in contact with a surface of the printing system component and a surface of the second textile pad can be in contact with a surface of the printing system component and at least the surface of the second textile pad can be in contact with the first textile pad.

6. The printing system component as in clause 5, where the second textile pad can be removably attached to the printing system component.

7. The printing system component as in any one of clauses 1-5, where the wick assembly can be removably attached to the printing system component.

8. A printing system includes a printing system component positioned opposite a moving print media, and a wick assembly attached to the printing system component.

9. The printing system in clause 8 can include a protective layer connected to a surface of the printing system component that is opposite the moving print media.

10. The printing system in clause 8 or clause 9 can include a heating element within the wick assembly or in contact with the wick assembly, the printing system component, or the protective layer, individually or in combinations of some or all of the wick assembly, the printing system component, and the protective layer.

11. The printing system in any one of clauses 8-10 can include a vacuum assembly positioned opposite the moving print media to produce suction over the print media that pushes humid air or some condensation into the vacuum assembly.

12. The printing system as in any one of clauses 8-11, where the wick assembly can be attached to a downstream portion of the printing system component.

13. The printing system as in any one of clauses 8-12, where a surface of the first textile pad can be in contact with a surface of the printing system component and a surface of the second textile pad can be in contact with a surface of the printing system component and at least the surface of the second textile pad can be in contact with the first textile pad.

14. The printing system as in clause 13, where the second textile pad can be removably attached to the printing system component.

15. The printing system as in any one of clauses 8-13, where the wick assembly can be removably attached to the printing system component.

16. The printing system component as in any one of clauses 1-7 or the printing system as in any one of clauses 8-12, where the printing system component can include a linehead or a support structure for a linehead.

### Parts List

5 printing system
10 print media
12 feed direction
15 printing module
20 printing module
25 linehead
25-1 linehead
25-2 linehead
25-3 linehead
25-4 linehead
25-A linehead
27 clearance gap
30 support structure
32 printhead
34 nozzle array
36 overlap region
38 increased condensation region
40 dryer
42 heat
45 quality control sensor
50 turnover module
53 wick assembly
54 heating element
55 textile pad
57 textile pad
59 surface of textile pad 57
60 surface of textile pad 55
61 surface of textile pad 57
62 surface of textile pad 57
63 printing system
65 vacuum assembly
66 print media transport rollers
67 suction
69 printing system
70 protective layer
73 slots
75 sealing structure
77 opening
79 attachment material
80 cover
83 expansion joint
85 locating tab
87 printing system
89 printing system
90 roller assembly

1. A printing system component, comprising:
a wick assembly attached to the printing system component.

2. The printing system component as in claim 1, wherein the printing system component comprises one of a linehead and a support structure for a linehead.

3. The printing system component as in claim 1, further comprising a heating element in contact with a surface of the printing system component.

4. The printing system component as in claim 1, wherein the wick assembly is attached to a downstream portion of the printing system component.

5. The printing system component as in claim 1, further comprising a protective layer connected to a surface of the printing system component that is opposite a moving print media.

6. The printing system component as in claim 5, further comprising a heating element in contact with the protective layer.

7. The printing system component as in claim 1, wherein the wick assembly comprises a first textile pad and a second textile pad, wherein a surface of the first textile pad is in contact with a surface of the printing system component and a surface of the second textile pad is in contact with another surface of the printing system component and the first textile pad.

8. The printing system component as in claim 7, wherein the second textile pad is removably attached to the printing system component.

9. The printing system component as in claim 1, wherein the wick assembly is removably attached to the printing system component.

10. A printing system, comprising:
a printing system component positioned opposite a moving print media; and
a wick assembly attached to the printing system component.

11. The printing system as in claim 10, wherein the printing system component comprises one of a linehead and a support structure for a linehead.

12. The printing system as in claim 10, further comprising a heating element in contact with a surface of the printing system component.

13. The printing system as in claim 10, further comprising a protective layer connected to a surface of the printing system component opposite the moving print media.

14. The printing system as in claim 13, further comprising a heating element in contact with the protective layer.

15. The printing system as in claim 10, further comprising a vacuum assembly positioned opposite the moving print media to produce suction over the print media that pushes humid air or some condensation into the vacuum assembly.

16. The printing system as in claim 10, wherein the wick assembly comprises a first textile pad and a second textile pad, wherein a surface of the first textile pad is in contact with a surface of the printing system component and a surface of the second textile pad is in contact with another surface of the printing system component and the first textile pad.

17. The printing system as in claim 16, wherein the second textile pad is removably attached to the printing system component.

18. The printing system as in claim 10, wherein the wick assembly is removably attached to the printing system component.
